(19) United States
(12) Patent Application Publication
(10) Pub. No.: US 2026/0286876 A1
(43) Pub. Date: Sep. 24, 2026

(54) Tank for Containing Automotive Liquid Reducing Agent

(71) Applicant: Volkswagen Truck & Bus Indústria e Comércio de VeÍculos Ltda, São Paulo (BR)

(72) Inventor: Sergio Roberto Amaral, Resende (BR)

(21) Appl. No.: 19/474,274

(22) PCT Filed: Apr. 5, 2024
(86) PCT No.: PCT/BR2024/050141

§ 371 Date: Oct. 10, 2025

(30) Foreign Application Priority Data
Apr. 10, 2023 (BR) 1020230066364

(51) Int. Cl. F01N 3/20; C08F 10/02

(52) U.S. Cl. CPC F01N 3/206; C08F 10/02; F01N 2610/1406

(57) ABSTRACT

The present invention refers to a tank (1) for containing automotive liquid reducing agent comprising a body (2) formed at least partially by a high-density polyethylene, wherein the high-density polyethylene is obtained from at least one biomass source of raw material, providing an ecologically sustainable alternative for the automotive tanks used today for the same function.

The present invention refers to an automotive tank, particularly for containing automotive liquid reducing agent (ARLA), which is formed by a material derived from biomass source, providing an ecologically sustainable alternative for the automotive tanks used today for the same function.

### DESCRIPTION OF THE STATE OF THE ART

One of the most controversial points of the road transport and cargo sector in general is the high level of pollution to the air caused by the use of fuels such as diesel, and one of the major pollutants originating from the burning of this type of fuel are the nitrogen oxides. In order to slow down this pollution generated in this type of application, the vehicles currently have catalytic reduction systems that are capable of breaking at least part of the harmful substances into non-harmful substances. The working of these catalytic reduction systems involves the use of an automotive liquid reducing agent (commonly called ARLA), which is capable of burning the nitrogen oxides derived from burning the diesel into non-harmful substances such as nitrogen and water.

Said ARLA is usually contained in tanks produced in high-density polyethylene (PEAD). PEAD is used for this type of tank simply because it is the same material used for the production of other components of the vehicle such as, for example, the fuel tanks, which is convenient from the logistical point of view, and may also be produced by the same manufacturing process as conventional fuel tanks.

It so happens that PEAD used in fuel tanks is manufactured through the use of ethylene (or ethene) derived from cracking naphtha and treating natural gas, two products derived from petroleum. Accordingly, the manufacturing process of the PEAD used in the production of ARLA tanks today is highly pollutant, resulting in a substantial emission of CO2 in the manufacturing process thereof.

A contradiction is therefore noted in the manufacture and use of ARLA tanks, in the sense that these tanks are used for containing a substance utilized to break down harmful materials derived from the combustion of fossil fuels such as diesel, but its manufacturing process in and of itself results in the emission of a large quantity of harmful substances into the environment.

### OBJECTIVES OF THE INVENTION

A first objective of the present invention is to provide an automotive tank for containing automotive liquid reducing agent (ARLA) that is formed by a material derived from a biomass source.

A second objective of the present invention is to provide an automotive tank for containing an automotive liquid reducing agent (ARLA) that is an ecologically sustainable alternative for the automotive tanks used today for the same function.

A third objective of the present invention is to provide an automotive tank for containing automotive liquid reducing agent (ARLA) that satisfies the validation norms applicable to this type of tank, such as NBR11473, NBR11474, NBR11478 and NBR11479.

### BRIEF DESCRIPTION OF THE INVENTION

The present invention refers to a tank for containing an automotive liquid reducing agent comprising a body formed at least partially by a high-density polyethylene, wherein the high-density polyethylene is obtained through at least one raw material of biomass source.

In a possible embodiment, the process of obtaining high-density polyethylene involves at least one stage of polyaddition or chain polymerization that does not generate subproducts.

In another possible embodiment, the high-density polyethylene is derived from an ethylene obtained from sugar cane processing.

In another possible embodiment, the high-density polyethylene is obtained through a process involving the stages of sugar cane processing for producing ethanol; dehydration of the alcohol obtained for obtaining ethylene; and polymerization of the ethylene through a process involving at least one stage of polyaddition or chain polymerization that does not generate subproducts, for obtaining high-density polyethylene.

### SUMMARY DESCRIPTION OF THE DRAWINGS

The present invention will now be described in greater detail, based on a sample embodiment represented in the drawings. The figures show:

FIG. 1—is a view of an automotive tank for containing an automotive liquid reducing agent (ARLA) of the present invention in a first embodiment; and

FIG. 2—is a view of an automotive tank for containing an automotive liquid reducing agent (ARLA) of the present invention in a second embodiment.

### DETAILED DESCRIPTION OF THE DRAWINGS

Firstly, it is important to note that the term “preferred” used herein characterizes an embodiment of particular efficiency of the invention among the multiple possible ones. Said “preferred” should not be construed as limiting on the possible embodiments of the present invention, meaning it should not be understood as “imperative” or “compulsory” for carrying out the present invention.

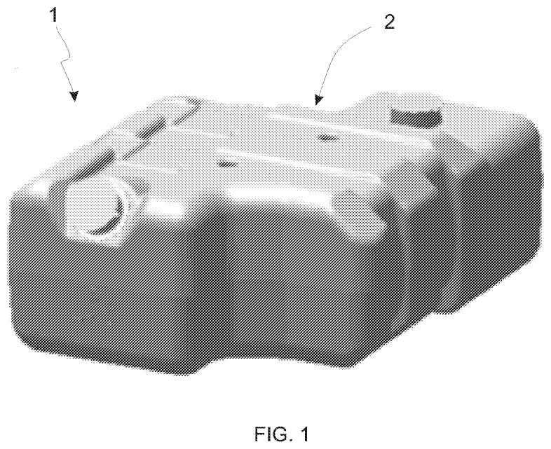

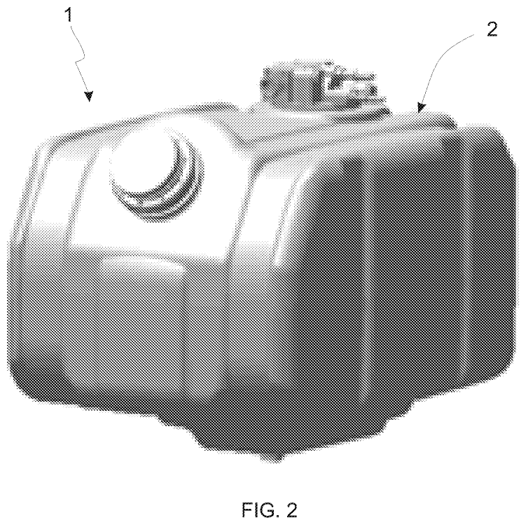

FIGS. 1 and 2 disclose possible embodiments of the invention regarding the geometric shape of the automotive tank 1 of the present invention. Nevertheless, it will be understood that the automotive tank 1 may contain any possible and necessary constructive arrangements for the correct utilization thereof in containing automotive liquid reducing agent (ARLA), and that the arrangement may vary significantly, depending on multiple factors, such as the vehicle type or model on which the tank will be used.

The main function of the tank 1 proposed herein is to store automotive liquid reducing agent (ARLA), which varies in size and volume, in accordance with the strategy of each manufacturer of commercial vehicles. It will be understood that the tank 1 has diverse geometry characteristics which may vary to meet the needs of available space (“package”) to be positioned within the length limits of the tubes that do the transport of the ARLA as far as the exhaustion system, defined by a systemist, manufacturer of the post-treatment equipment.

The tank 1 of the present invention in the embodiments disclosed in FIGS. 1 and 2 comprises a body 2 formed at least partially by a high-density polyethylene, wherein the high-density polyethylene is obtained by the use of at least one raw material of biomass source.

The use of a high-density polyethylene (PEAD) derived from a raw material of biomass source makes it possible to eliminate from the production chain, at least partially, the need to use ethylene (or ethene) derived from cracking of naphtha and the treatment of natural gas for the manufacture thereof, which significantly reduces the emission of CO2 arising from this type of process.

For purposes of clarification, the term “obtained” should be understood as processed, manufactured or any other form of obtaining or acquiring the high-density polyethylene. The term “obtained by the use of at least one raw material of biomass source” should be understood as processed, manufactured or otherwise obtained, wherein at least one step of production or obtainment involves the use of a raw material of biomass source. For example, the high-density polyethylene can be obtained by way of the ethylene obtained from sugar cane processing. In this sense, in one embodiment, the sugar cane is processed normally to produce ethanol, and the alcohol produced undergoes a process of dehydration in order to obtain ethylene. The ethylene is then polymerized through a process involving, preferably, at least one step of polyaddition or chain polymerization that does not generate subproducts. It shall be understood that other biomass sources can be used to obtain by one the high-density polyethylene through a process similar to the one described above, or by other suitable known processes.

Other examples of biomass source include corn, potato, beetroot, peanut, lignocellulosic sources (wood and grasses). Other examples of processes for producing high-density polyethylene include processes used in the production of second-generation bioenergy, which is ethanol. The synthesis thereof produces the ethylene. Another example is the bioconversion process of wood residues into bioethylene.

The use of a high-density polyethylene (PEAD) for composition of the body 2 of the tank 1 guarantees that, despite not boasting the same physical and mechanical properties of a material usually used in a fuel tank, the material of said tank 1 will allow it to adequately satisfy the validation standards applicable to this type of object, such as the standards NBR11473, NBR11474, NBR11478 and NBR 11479.

As already mentioned, it has to be noted that the material used for ARLA containment tanks from the state of the art is the same type of material used for fuel containment tanks, for logistical reasons. However, this type of material used in tanks from the state of the art was developed for approval in flammability tests, as it is used in diesel oil tanks, for example. Moreover, ARLA containment tanks typically transport water in a solution with 32.5% urea (ARLA 32), and this type of liquid is not inflammable. Therefore, the state of the art uses a material for producing ARLA containment tanks with characteristics that are not even needed for this type of application.

Advantageously, the present invention provides, through the use of high-density polyethylene derived from a raw material biomass source, an alternative that not only satisfies current ecological needs, but also has suitable physical and mechanical characteristics for this type of ARLA contention application, complying with all applicable standards, and without having to resort to materials having characteristics that are not very useful for this type of application.

Having described an example of a preferred embodiment, it should be understood that the scope of the present invention encompasses other possible variations, being limited only by the content of the accompanying claims, potential equivalents being included therein.

1. (canceled)

2. (canceled)

3. (canceled)

4. (canceled)

5. A tank for containing automotive liquid reducing agent, comprising a body formed at least partially by a high-density polyethylene, wherein the high-density polyethylene is obtained through at least one raw material of biomass source.

6. The tank for containing automotive liquid reducing agent, according to claim 5, wherein the process of obtaining the high-density polyethylene involves at least one step of polyaddition or chain polymerization that does not generate subproducts.

7. The tank for containing automotive liquid reducing agent, according to claim 5, wherein the high-density polyethylene is derived from an ethylene obtained from sugar cane processing.

8. The tank for containing automotive liquid reducing agent, according to claim 6, wherein the high-density polyethylene is derived from an ethylene obtained from sugar cane processing.

9. The tank for containing automotive liquid reducing agent, according to claim 5, wherein the high-density polyethylene is obtained through a process involving the steps of:
processing the sugar cane for producing ethanol;
dehydrating the alcohol obtained for obtaining ethylene; and
polymerizing the ethylene through a process involving at least one step of polyaddition or chain polymerization that does not generate subproducts, for obtaining high-density polyethylene.

10. The tank for containing automotive liquid reducing agent, according to claim 6, wherein the high-density polyethylene is obtained through a process involving the steps of:
processing the sugar cane for producing ethanol;
dehydrating the alcohol obtained for obtaining ethylene; and
polymerizing the ethylene through a process involving at least one step of polyaddition or chain polymerization that does not generate subproducts, for obtaining high-density polyethylene.

11. The tank for containing automotive liquid reducing agent, according to claim 7, wherein the high-density polyethylene is obtained through a process involving the steps of:
processing the sugar cane for producing ethanol;
dehydrating the alcohol obtained for obtaining ethylene; and
polymerizing the ethylene through a process involving at least one step of polyaddition or chain polymerization that does not generate subproducts, for obtaining high-density polyethylene.

12. The tank for containing automotive liquid reducing agent, according to claim 8, wherein the high-density polyethylene is obtained through a process involving the steps of:
processing the sugar cane for producing ethanol;
dehydrating the alcohol obtained for obtaining ethylene; and
polymerizing the ethylene through a process involving at least one step of polyaddition or chain polymerization that does not generate subproducts, for obtaining high-density polyethylene.
